(19) United States
(12) Patent Application Publication
(10) Pub. No.: US 2010/0299219 A1
(43) Pub. Date: Nov. 25, 2010

(54) Configuration and Management of Add-ons to Digital Application Programs for Network-Based Distribution

(76) Inventors: Ricardo D. Cortes, Los Gatos, CA (US); Max Muller, San Jose, CA (US); Aloke Bhatnagar, Campbell, CA (US); Jonathan B. Leffert, Redwood, CA (US); Jeffrey Allen Clites, San Jose, CA (US)

Correspondence Address: TI Law Group, 2055 Junction Avenue, #205, San Jose, CA, 95131-2116, US

(21) Appl. No.: 12/571,260

(22) Filed: Sep. 30, 2009

Related U.S. Application Data
(60) Provisional application No. 61/180,925, filed on May 25, 2009.

(51) Int. Cl. G06Q 30/00; G06Q 50/00; G06F 21/00

(52) U.S. Cl. 705/26; 726/3; 726/26

(57) ABSTRACT

An improved system and method for configuring, submitting, distributing and/or managing add-ons for digital products previously submitted to a product distribution site are disclosed. The add-ons for digital products can be managed and made available for online purchase and distribution at the product distribution site. An add-on for a digital product can subsequently be offered to and acquired by an interested person that previously purchased the associated digital product through use of the digital product itself, which can interact with a product distribution site. The product distribution site can also be referred to as an online product hosting site. In one embodiment, the digital products are computer program products (e.g., computer software programs).

### CROSS-REFERENCE TO RELATED APPLICATION

This application claims priority to U.S. Provisional Patent Application No. 61/180,925, filed May 25, 2009, entitled “CONFIGURATION AND MANAGEMENT OF ADD-ONS TO DIGITAL APPLICATION PROGRAMS FOR NETWORK-BASED DISTRIBUTION”, which is hereby incorporated herein by reference.

### BACKGROUND OF THE INVENTION

Today, online media stores, such as iTunes™ Media Store, allow customers (i.e., online users) to purchase or rent media items, such as music or videos, over the Internet. Often, at online media stores, numerous media items made available and are provided by various different content providers, such as music labels or movie companies. Software tools, such as iProducer™ and Label Connect™ available from Apple Inc. of Cupertino, Calif., can assist content providers with online submission of media content to the iTunes™ Media Store.

Software programs are also available to purchased or licensed at retail stores as well as online stores. Conventionally, a software program is primarily purchased as a compact disc (CD) containing the software program. Alternatively, purchasers can often purchase and download a software program from an online retailer or a software provider's website. However, when an online retailer operates to sell software programs of various independent parties, there are difficulties in providing the digital program files and supporting information/files to the online retailers. These difficulties are exacerbated by a large number of small software providers that often desire to partner with the online retailer. As a result, online retailers that receive online submissions can face substantial burdens and difficulties due to the wide range of variation with respect to the submissions.

Also, when an improvement to a software program is made available for distribution, conventionally a software provider would (i) produce and distribute another compact disc (CD) containing the improved version of the software program and/or (ii) would render the improved version of the software program available for purchase and download from an online retailer. The user could then purchase and acquire (e.g., download) the improved version of the software program (which would be used in place of its older version).

There is, however, a need for improved approaches to facilitate distribution of enhancements to software programs by retailers, such as online retailers.

### SUMMARY

The invention relates to an improved system and method for provisioning, configuring, submitting, distributing and/or managing add-ons for digital products previously submitted to a product distribution site. The add-ons for digital products can be managed and made available for online purchase and distribution at the product distribution site. An add-on for a digital product can subsequently be offered to and acquired by an interested person that previously purchased the associated digital product through use of the digital product itself, which can interact with a product distribution site. The product distribution site can also be referred to as an online product hosting site. In one embodiment, the digital products are computer program products (e.g., computer software programs).

In one embodiment, the invention pertains to a method and system for controlled provisioning of add-ons for digital products in a client-server environment. The controlled provisioning can assist a user in properly configuring add-ons for digital products. The method and system can use user accounts to restrict unauthorized access.

The invention can be implemented in numerous ways, including as a method, system, device, apparatus (including computer readable medium and graphical user interface). Several embodiments of the invention are discussed below.

As a computer-implemented method for managing distribution of an add-on for a digital product by an online repository, one embodiment can, for example, include at least: displaying a list of one or more application computer programs previously submitted to the online repository; receiving a selection of one of the application computer programs previously submitted, the selected application computer program including an add-on contained therein whose access is locked; receiving add-on management information to configure unlocking of the locked add-on; and providing the add-on management information to the online repository for managing distribution of the add-on for the digital product for the selected application computer program to the online repository for distribution.

As a computer readable storage medium including at least computer program code stored thereon for managing distribution of an add-on for a digital product by an online repository, one embodiment can, for example, include at least: computer program code for displaying a list of one or more application computer programs previously submitted to the online repository; computer program code for receiving a selection of one of the application computer programs previously submitted, the selected application computer program including an add-on contained therein whose access is locked; computer program code for receiving add-on management information to configure unlocking of the locked add-on; and computer program code for providing the add-on management information to the online repository for managing distribution of the add-on for the digital product for the selected application computer program to the online repository for distribution.

As a system for facilitating submission and management of digital products to be distributed online, one embodiment can, for example, include at least: a product management and distribution system configured to permit content providers to submit digital products and manage distribution of their digital products. The product management and distribution system including at least: (i) a product submission module configured to receive submission of digital products for distribution, with each of the digital products being submitted including at least providing product information and product distribution information; and (ii) an add-on submission module configured to receive submission of add-ons, the add-ons being distributed along with a corresponding one or more of the digital products, with each of the add-ons being submitted including at least add-on information and add-on distribution information. The product information includes at least a product name and a supported device type indication, and wherein the product distribution information includes at least one pricing parameter for use in online distribution of the corresponding digital product. The add-on information includes at least an add-on name and an add-on description, and the add-on distribution information includes at least one pricing parameter for use in online distribution of the corresponding add-on.

As a system for facilitating submission and management of digital products to be distributed online, one embodiment can, for example, include at least: a product management and distribution system configured to permit content providers to submit information for use in distribution of add-ons for digital products and manage access to the add-ons. The product management and distribution system can include at least an add-on submission module configured to receive submission of add-ons. The add-ons are distributed along with a corresponding one or more of the digital products, each of the add-ons being submitted include at least add-on information and add-on distribution information. The add-on information includes at least an add-on name and an add-on description. The add-on distribution information includes at least one pricing parameter for use in online distribution of the corresponding add-on.

As a graphical user interface for use in submitting a digital product to an online distribution site, one embodiment can, for example, include at least an add-on creation window and an add-on creation window. The add-on creation window for assisting a user in designating an application program to support an add-on. The designated application program was previously submitted to the online distribution site, and the designated application program including computer program code for not only the designated application program but also at least one add-on. The add-on creation window assists the user in providing at least a pricing parameter for the add-on and add-on metadata for the add-on for the designated application program.

As a method for submitting an add-on for a digital product to an online repository for distribution, one embodiment can, for example, include at least: receiving add-on information pertaining to the add-on for the digital product to be distributed by the online repository; receiving at least one distribution parameter to be used for the add-on; and submitting the add-on to the online repository for distribution.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system according to one embodiment.

FIG. 2 is a flow diagram of an add-on submission process according to one embodiment.

FIG. 3 is a flow diagram of an add-on creation process according to one embodiment.

FIG. 4 is a flow diagram of a product submission and management process according to one embodiment.

FIG. 5 is a block diagram of a product submission and management system according to one embodiment.

FIG. 6 is a block diagram of an add-on management system according to one embodiment.

FIGS. 7A-7K are representative screen shots pertaining to basic user interaction with a product submission and management system according to one embodiment.

### DETAILED DESCRIPTION OF CERTAIN EMBODIMENTS

The invention relates to an improved system and method for provisioning, configuring, submitting, distributing and/or managing add-ons for digital products previously submitted to a product distribution site. The add-ons for digital products can be managed and made available for online purchase and distribution at the product distribution site. An add-on for a digital product can subsequently be offered to and acquired by an interested person that previously purchased the associated digital product through use of the digital product itself, which can interact with a product distribution site. The product distribution site can also be referred to as an online product hosting site. In one embodiment, the digital products are computer program products (e.g., computer software programs).

In one embodiment, the invention pertains to a method and system for controlled provisioning of add-ons for digital products in a client-server environment. The controlled provisioning can assist a user in properly configuring add-ons for digital products. The method and system can use user accounts to restrict unauthorized access.

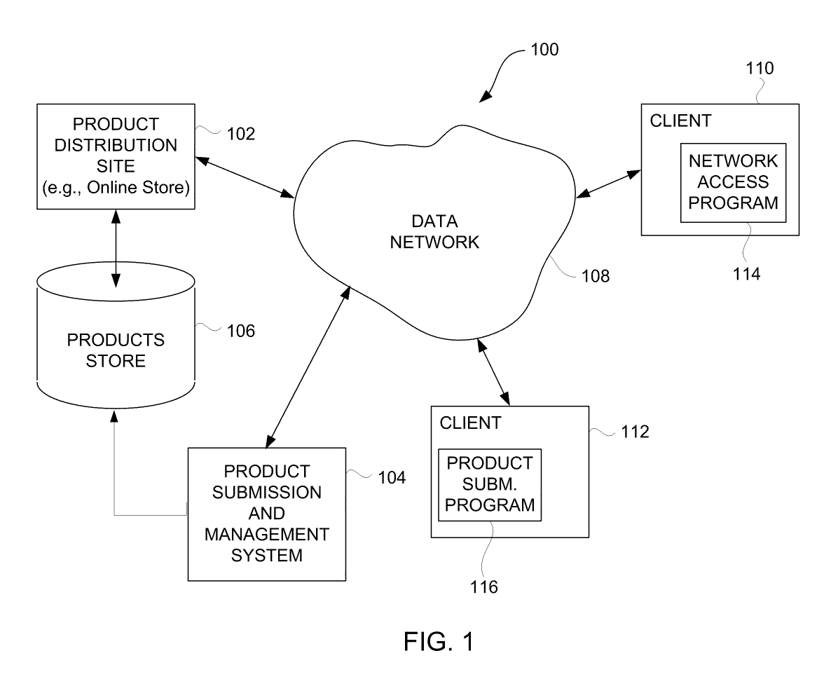

Embodiments of various aspects of the invention are discussed below with reference to FIGS. 1-7K. However, those skilled in the art will readily appreciate that the detailed description given herein with respect to these figures is for explanatory purposes as the invention extends beyond these limited embodiments.

FIG. 1 is a block diagram of a product submission and distribution system 100 according to one embodiment. The product submission and distribution system 100 includes a product distribution site 102. The product distribution site 102 provides an online access point for distribution of various digital products. For example, the product distribution site 102 can be referred to as an online store. A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 includes a mass data store and one or more databases. The products store 106 provides mass storage of the numerous digital products that are available for distribution (e.g., purchase or rental). For example, digital products that have been purchased can be accessed from the products store 106 over a data network 108 by way of the product distribution site 102. Examples of digital products are computer program products such as applications (or application programs), animations, or presentations.

The product submission and distribution system 100 also includes a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 is coupled to the product distribution site 102 through the data network 108. Hence, any of the first clients 110 can interact with the product distribution site 102 to review, purchase and/or manage digital products.

The product submission program 116 is also an application program (e.g., software application) that operates on the second client 112, which is a computing device. The product submission program 116 can be used to submit digital products to the product submission and management system 104 for eventual distribution by the media distribution site 102. Although the network access program 114 and the product submission program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission program 116. The digital products that have been submitted (e.g., via the second client 112 are processed and then stored in the products store 106. Thereafter, the stored digital products are available to be purchased from the product distribution site 102. Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before persistently stored on the client 110. Thereafter, the client 110 can utilize (e.g., execute) the digital data of the digital product at the client 110.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user is credited for a purchase or rental amount of the particular digital product.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 includes at least a portion of the Internet. The clients 110, 112 can vary with application but generally are computing devices that have memory storage. Often, the clients 110, 112 are personal computers or other computing devices that are capable of storing and presenting media to their users. In one embodiment, the connections through the data network 108 between the product distribution site 102 and the clients 110, 112 can be through secure connections, such as Secure Sockets Layer (SSL).

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

After a digital product has been submitted to a product submission and management system, a quality review process can be initiated. The quality review can have a number of states, including: in review, ready for sale, rejected or pending contract. The “in review” state is the initial state until the submission is rejected or approved. The “ready for sale” state is the status once the application file has been approved. The “rejected” state is the status if quality review finds the application filed deficient or defective. The “pending contract” state is the state when submitter lacks a contractual agreement for distribution.

Additionally, the product submission and distribution system 100 can facilitate distribution of add-ons for the digital products. The add-ons can pertain to additional features of an associated application program. For example, an application program can be configured to have one or more additional features that can be later accessed, such as “unlocked”, so that access to such one or more additional features can be acquired. The additional features can be submitted to the product submission and management system 104 via the product submission program 116. The additional features are associated with a digital product. In one embodiment, the features are embedded in the digital product that a user previously acquired, and thus such features can be later “unlocked” for the user if appropriate conditions are met. Typically, the user is required to pay an additional fee to gain access to one or more of the features.

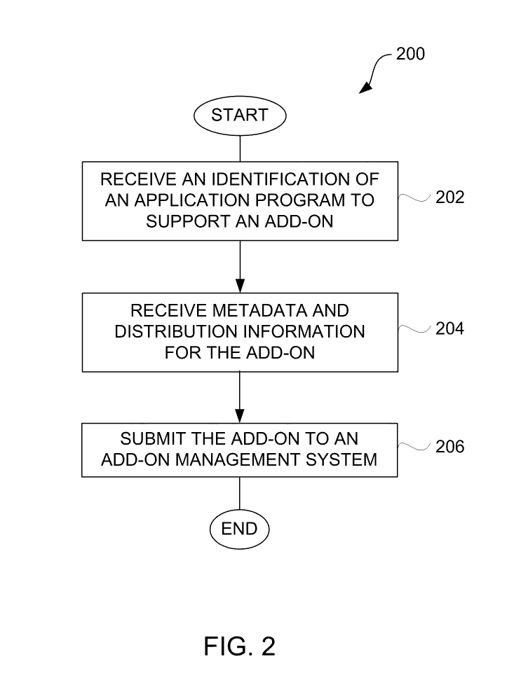

FIG. 2 is a flow diagram of an add-on submission process 200 according to one embodiment. The add-on submission process 200 can, for example, be performed by a client device, such as the client 114, and/or a server device, such as the product submission and management system 104.

The add-on submission process 200 receives 202 an identification of an application program that is to support an add-on. Typically, the application program is one of one or more application programs that had been previously submitted to any product submission and management system, such as the product submission and management system 104 illustrated in FIG. 1. The one more application programs can also be referred to as computer program products. The add-on is a feature of the application program that has been identified. Next, metadata and distribution information for the add-on is received 204. Examples of the metadata can include a name and a description for the add-on. The distribution information can include a pricing parameter. As an example, a pricing parameter can specify a price or a price tier to be associated with the add-on. Other distribution parameters can pertain to a unique identifier (e.g., SKU number) to be used to identify the add-on. Still further, distribution parameters could also indicate a sale start date and/or a cleared for sale flag. Subsequently, the add-on can be submitted 206 to an add-on management system. The add-on management system can manage the availability of the add-on by the identified application program. For example, assuming that the user previously purchased the identified application program, the add-on management system can interact with the computing performing the identified application program to authorize payment for the add-on as well as to cause the add-on to be made available to the identified application program. In one embodiment, the add-on management system can be implemented by a portion of the product submission and management system 104 illustrated in FIG. 1. The product distribution site 102, which can host an online repository, can operate to permit distribution of the digital product, together with an incorporated “locked” add-ons, in accordance with the one or more distribution parameters. After the submission 206, the add-on submission process 200 can end.

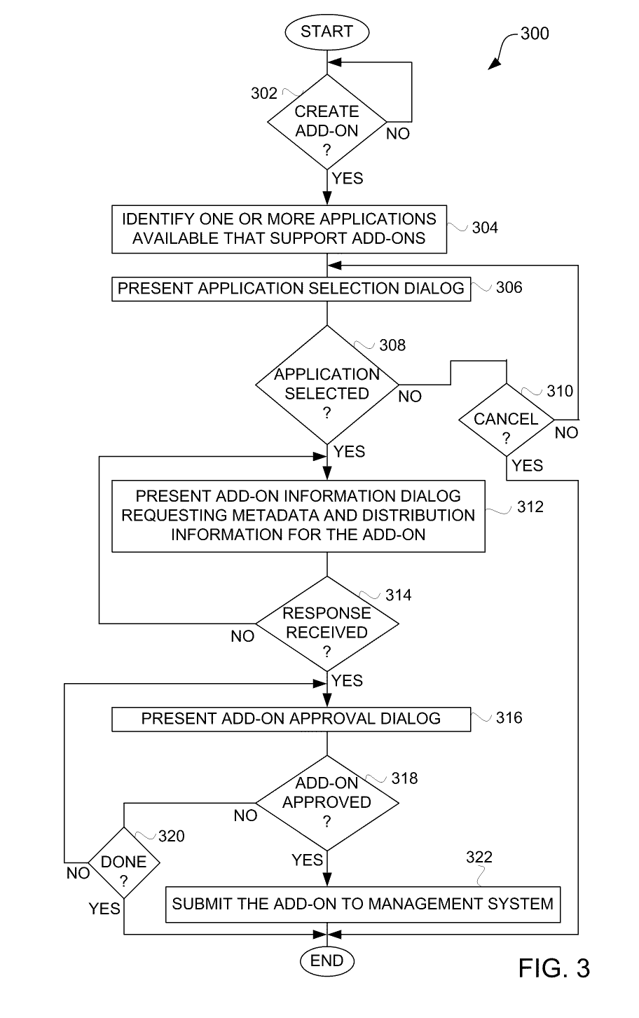

FIG. 3 is a flow diagram of an add-on creation process 300 according to one embodiment. The add-on creation process 300 can, for example, represent processing performed by the product submission and management system 104 and/or the product submission program 116 illustrated in FIG. 1.

The add-on creation process 300 can begin with a decision 302 that determines whether an add-on is to be created. When the decision 302 determines that an add-on is not to be created, the add-on creation process 300 can wait until an add-on is to be created. On the other hand, once the decision 302 determines that an add-on is to be created, the add-on creation process 300 can continue. When the add-on creation process 300 is to continue, one or more applications that are available to support add-ons can be identified 304. An application selection dialog can then be presented 306.

In one embodiment, an add-on is associated with an application program. For example, the identification 304 of the one or more available application programs that can support add-ons can be performed by querying the product submission and management system 104 for a list of application programs that are not only associated with the user but also permitted to provide add-ons. The application programs can be affiliated with users through use of user accounts. The product submission and management system 104 can use policies or rules to control those submitted application programs that are permitted to provide add-ons.

Next, a decision 306 determines whether an application has been selected. Here, in the application selected in the one of the one and more applications that was identified 304 as available to support add-ons. When the decision 308 determines that an application has not yet been selected, a decision 310 can determine whether the add-on creation process 300 is to be canceled. When the decision 310 determines that the add-on creation process 300 is not to be canceled, the add-on creation process 300 can returns to repeat the block 306.

Alternatively, when the decision 308 determines that an application has been selected, an add-on information dialogue can be presented 312. The add-on information dialogue can request metadata and/or distribution information for the add-on. For example, the user can interact with the add-on information dialog to provide the requested metadata and/or distribution information. Following the block 312, a decision 314 can determine whether a response to the add-on information dialog has been received. When the decision 314 determines that a response to the add-on information dialog has not yet been received, the add-on creation process 300 can return to repeat the block 312.

Once the decision 314 determines that a response to the add-on information dialog has been received, an add-on approval dialog can be presented 316. The add-on approval dialog can assist the user in approving the add-on being created. A decision 318 can then determine whether the add-on has been approved. When the decision 318 determines that the add-on has not yet been approved, a decision 320 can determine whether in the add-on creation process 300 is done. When the decision 320 determines that the add-on creation process 300 is not done, the add-on creation process 300 returns to repeat the block 316.

Alternatively, when the decision 318 determines that the add-on has been approved, the add-on can be submitted 322 to a management system. For example, the management system can pertain to the product submission and management system 104 illustrated in FIG. 1. Following the block 322, following the decision 320 when the add-on creation process 300 is done, or following the decision 310 when the add-on creation process 600 has been canceled, the add-on creation process 300 can end.

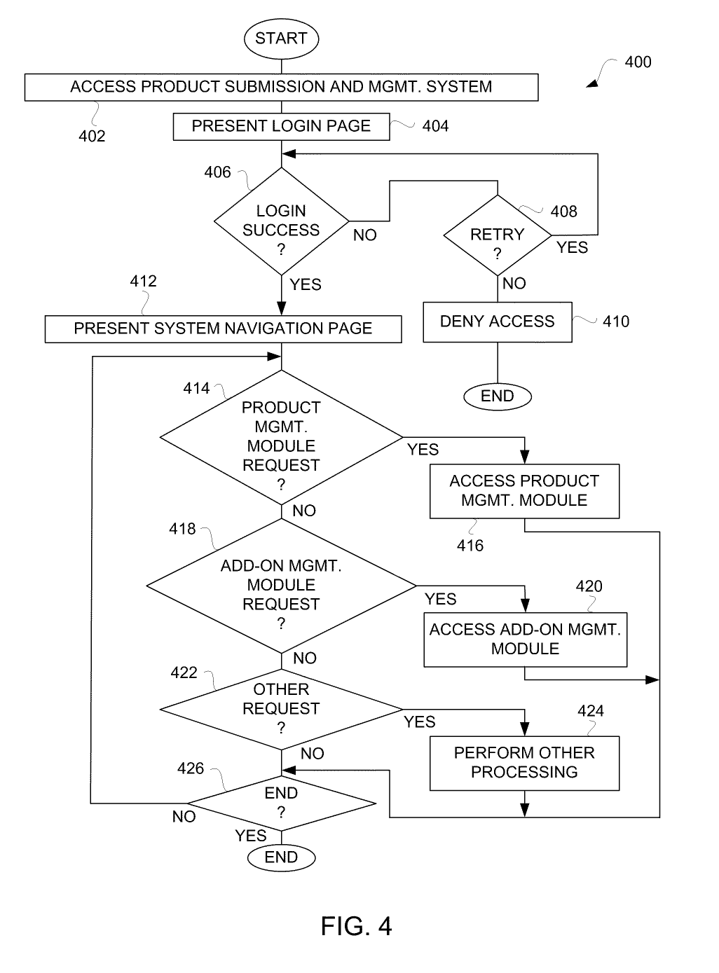

FIG. 4 is a flow diagram of a product submission and management process 400 according to one embodiment. The product submission and management process 400 can, for example, be performed by a product submission and management system.

The product submission and management process 400 can begin by accessing 402 the product submission and management system. A login page can then be presented 404 to the user seeking to submit a digital product to the product submission and management system. The user can then enter a user name and password. Thereafter, a decision 406 can determine whether login has been successfully achieved. When the decision 406 determines that login has not been successful, a decision 408 can determine whether a retry for the login is permitted. When the decision 408 determines that a retry is not permitted, access to the product submission and management system is denied 410. Following the block 410, the product submission and management process can end. Alternatively, when the decision 408 determines that a retry is permitted, the product submission and management process 400 can return to repeat the decision 406 so that another login attempt can be permitted.

When the decision 406 determines that login has been successfully achieved, a system navigation page can be presented 412. From the system navigation page, a plurality of different software modules can be accessed. In the embodiment illustrated in FIG. 4, the software modules include a product management module and an add-on module. However, additional modules, such as a contract request module, a royalty module, or an account management module could also be provided and navigated thereto. The user can interact with the system navigation page to activate any of these different software modules. More particularly, the processing associated with activating any the different modules is discussed below.

After the system navigation page has been presented 412, a decision 414 can determine whether a product management module request has been received. When the decision 414 determines that a product management module request has been received, a product management module can be accessed 416. On the other hand, when the decision 414 determines that a product management module request has not been received, a decision 418 can determine whether a request for access to an add-on management module has been received. When the decision 418 determines that a request to access the add-on management module has been received, an add-on management module can be accessed 420. Alternatively, when the decision 418 determines that a request to access an add-on management module has not been received, a decision 422 can determine whether some other request from the user has been received. When the decision 422 determines that some other request has been received, other processing can be performed 424. The other processing could, for example, pertain to a contract request module, a royalty module, and/or an account management module.

Following each of the blocks 416, 420 and 424 as well as following the decision 422 when some other request has not been received, a decision 426 can determine whether the product submission and management process 400 should end. When the decision 426 determines that the product submission and management process 400 should not end, the processing returns to perform the decision 414 and subsequent blocks so that subsequent user requests can be processed. However, when the decision 426 determines that the product submission and management process 400 should end, the product submission and management process 400 can end.

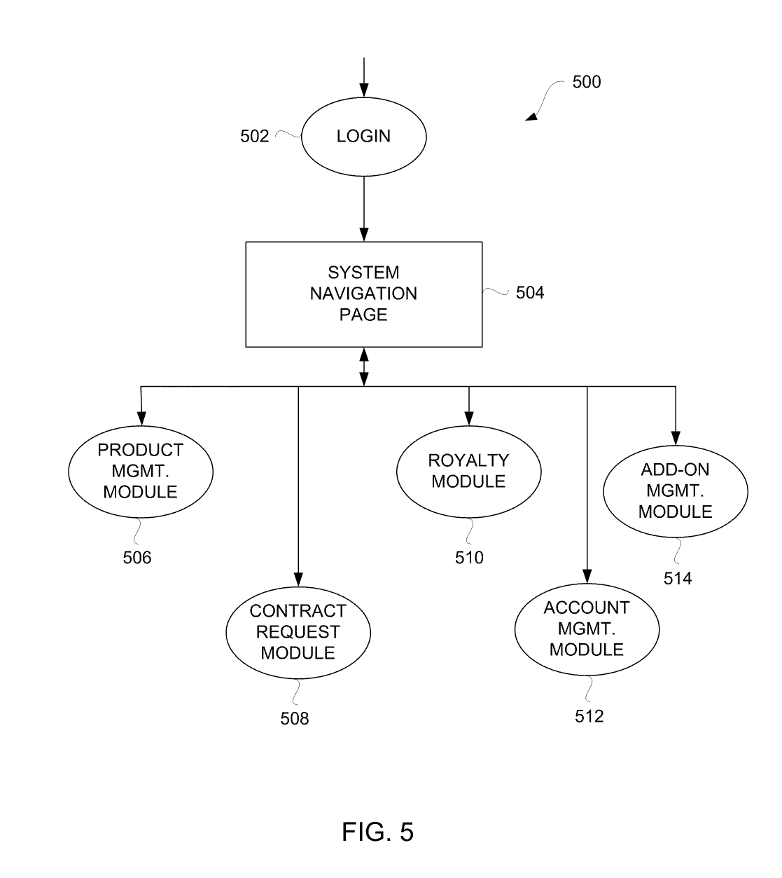

FIG. 5 is a block diagram of a product submission and management system 500 according to one embodiment. The product submission and management system 500 can, for example, represent one embodiment of the product submission and management system 104 illustrated in FIG. 1.

The product submission and management system 500 can require a login 502. For example, the login can require a user (i.e., digital product submitter) to provide a user name and a password. Typically, the login is associated with a user account that was previously established for the user. If the digital product submitter has successfully logged into the product submission and management system 500, the digital product submitter can be presented with a system navigation page 504. From the system navigation page 504, the digital product submitter can access one or more modules that are supported by the product submission and management system 500. According to one embodiment, as illustrated in FIG. 5, the modules supported by the product submission and management system 500 can include a product management module 506, a contract request module 508, a royalty module 510, an account management module 512, and an add-on module 514.

The product management module 506 can allow the digital product submitter to submit new products and control distribution of such new products. The product management module 506 can also allow the digital product submitter to edit previous submissions. The contract request module 508 can permit the digital product submitter to request a contract with an entity that provides the product distribution. Such a contract can enable the digital products submitter to distribute digital products using a product distribution site (e.g., online store) provided by the entity. The royalty module 510 can assist the digital product submitter in monitoring distribution of all digital products associated with the digital product submitter, including monitoring royalties that will or have in provided to the digital submitter due to distribution of such digital products. For example, the digital product submitter can access monthly royalty reports. The account management module 512 can provide centralized account management for the digital products, including, for example, access permissions, email settings, basic account information to be associated with the digital products matter. The add-on management module 506 can allow a digital product submitter to also configure or submit add-ons and control distribution of such add-ons.

As noted above, a project management system can include support for add-ons to application programs. In particular, a product submission and management system (e.g., the product submission and management system 104) for a project management system can include an add-on module that operates to facilitate creation and configuration of add-ons that are submitted or made available for distribution by a product distribution site (e.g., the product distribution site 102).

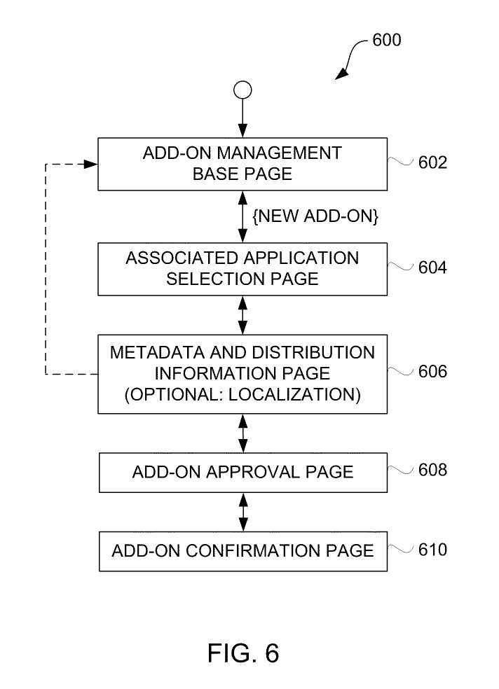

FIG. 6 is a block diagram of an add-on management system 600 according to one embodiment. The add-on management system 600 is, for example, implemented by a product submission and management system (e.g., product submission and management system 104). The add-on management system 600 can cause various graphical user interfaces to be presented to users of client machines (e.g., client 114). The add-on management system 600 provides an add-on management base page 602. From the add-on management base page 602, a user can determine whether to view existing add-ons or whether to create a new add-on. When a new add-on is to be created, an associated application selection page 604 can be presented. The associated application selection page 604 is utilized to assist the user in identifying a particular one of the application programs for which the add-on being created is to be associated. In other words, the add-on is to expand the functionality, content, data, tools, components, programming or the like for an application program, namely the particular one of the application programs that has been identified. Additionally, a metadata and distribution information page 606 can be presented. The metadata and distribution information page 606 can assist the user in providing metadata and/or distribution information for the add-on being created. The metadata and distribution information page 606 can also assist the user in providing localization information pertaining to the add-on.

Additionally, the add-on management system 600 can also utilize an add-on approval page 608. The add-on approval page 608 can assist the user in approving the add-on being created through use of the add-on management system 600. If the user approves the add-on, an add-on confirmation page 610 can be utilized to allow final confirmation for in the add-on being created.

Still further, although not illustrated in FIG. 6, the add-on management system 600 can also support management of add-ons associated with a particular application. Also, one or more of the pages provided by the add-on management system 600 can support search for add-ons affiliated with a given user account (e.g., across one or more applications).

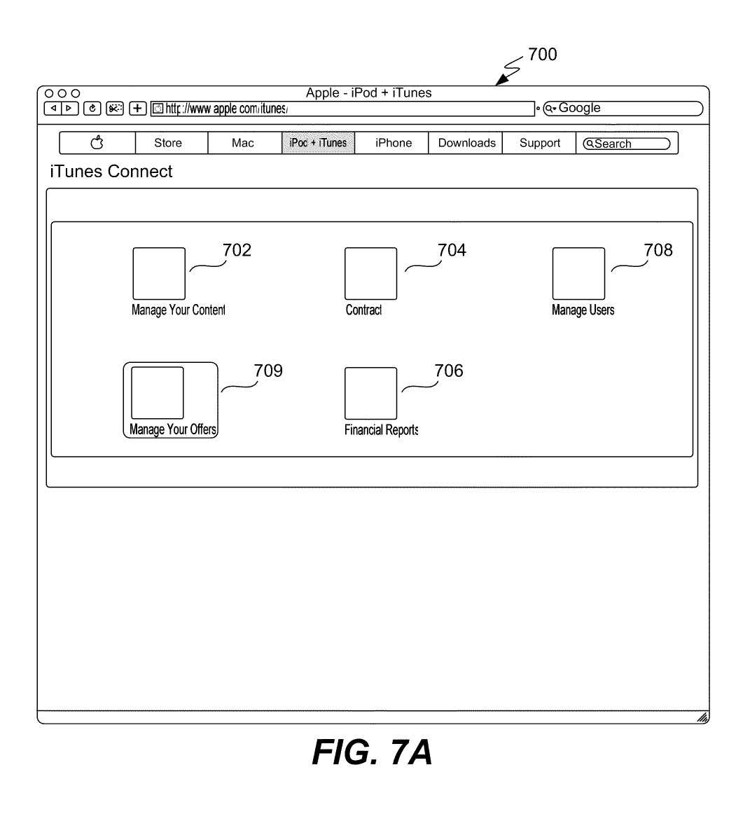

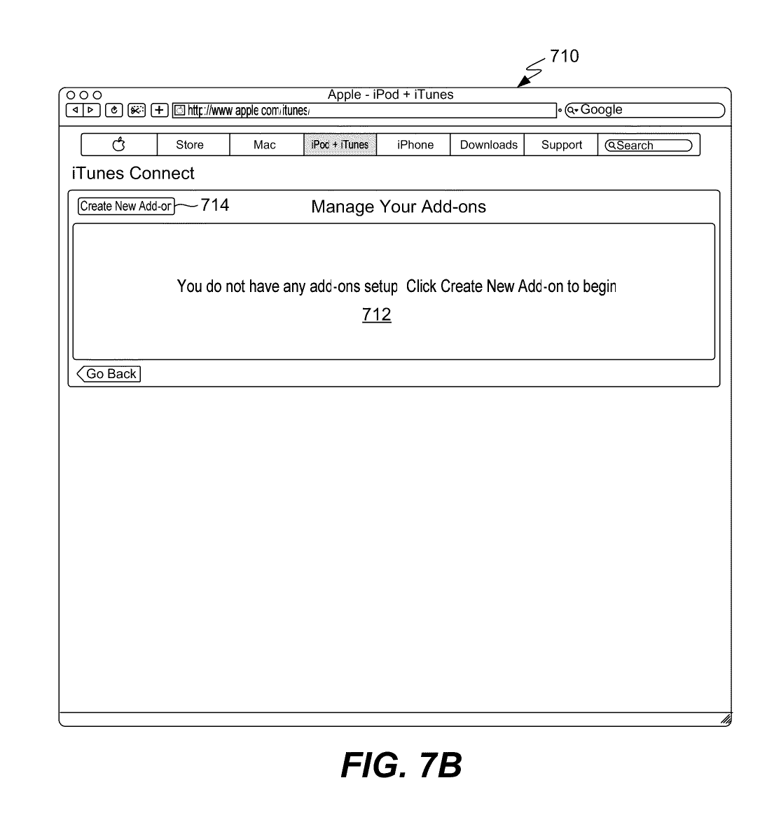

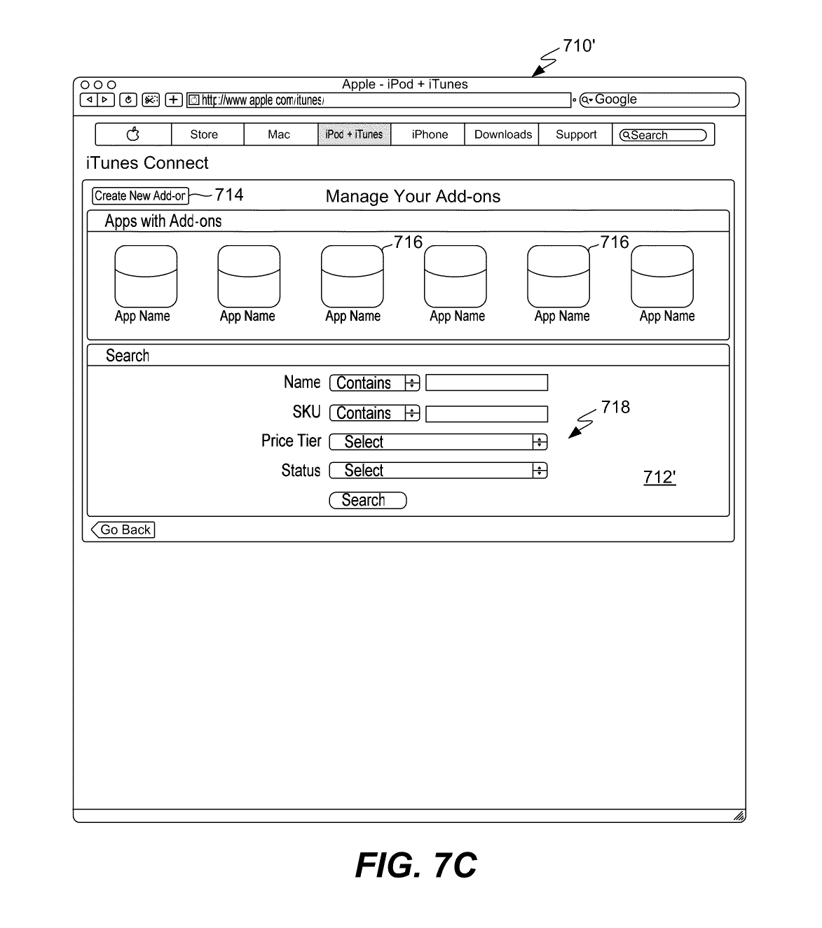

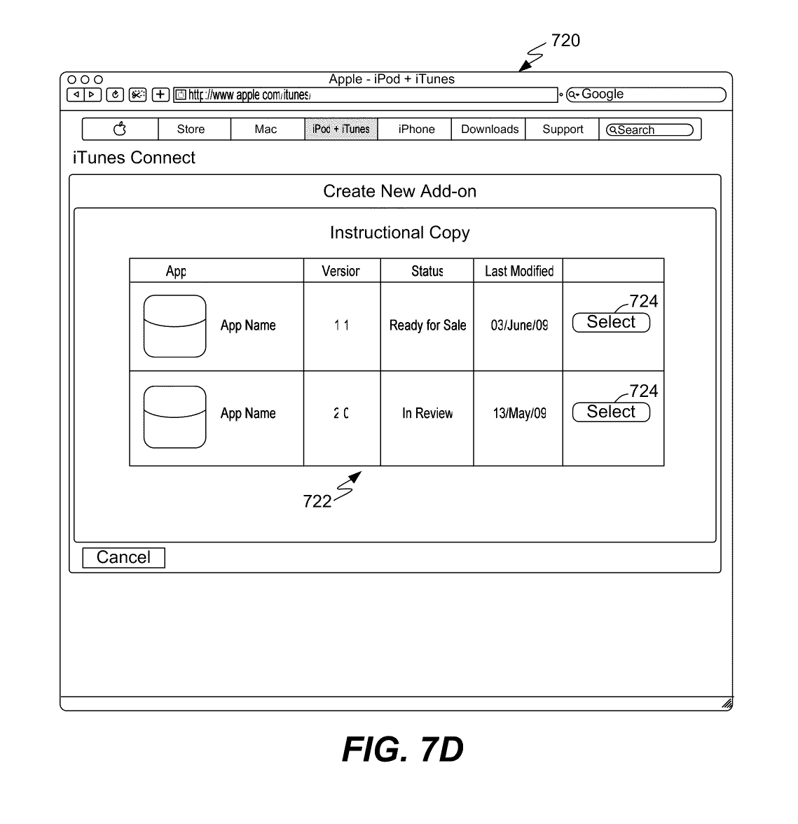

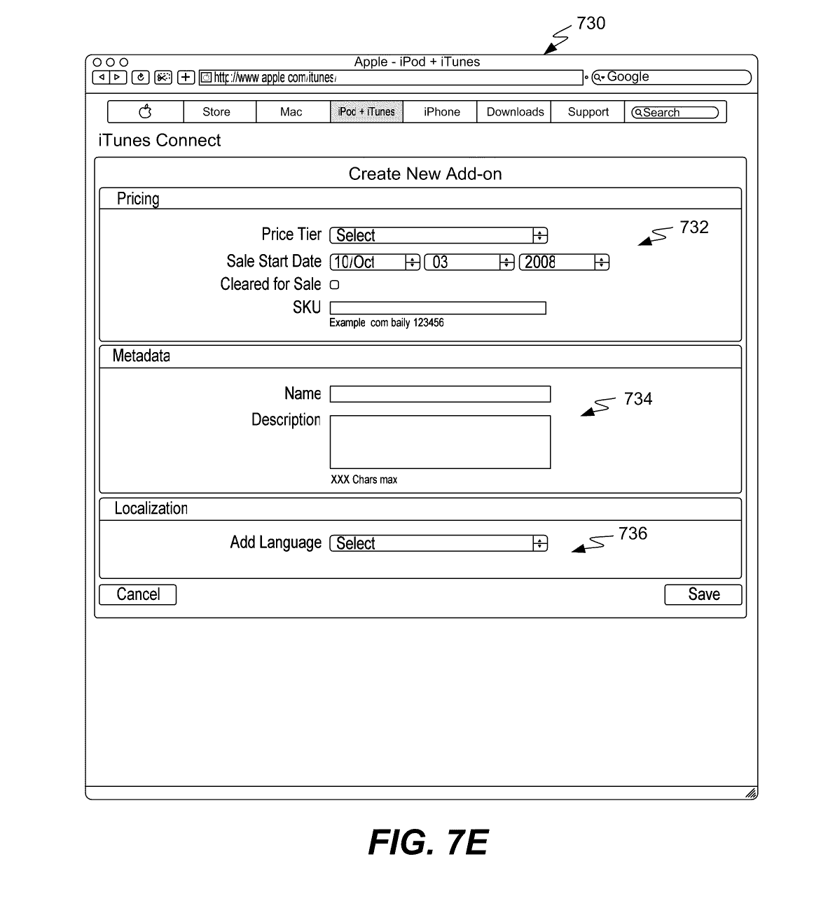

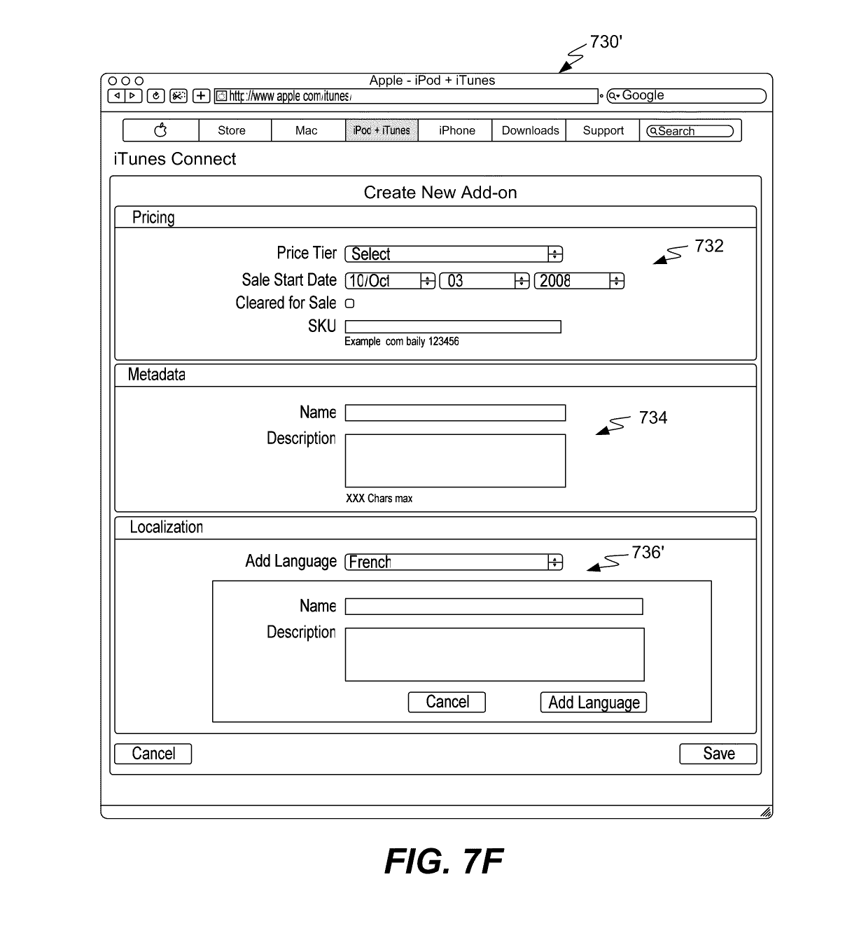

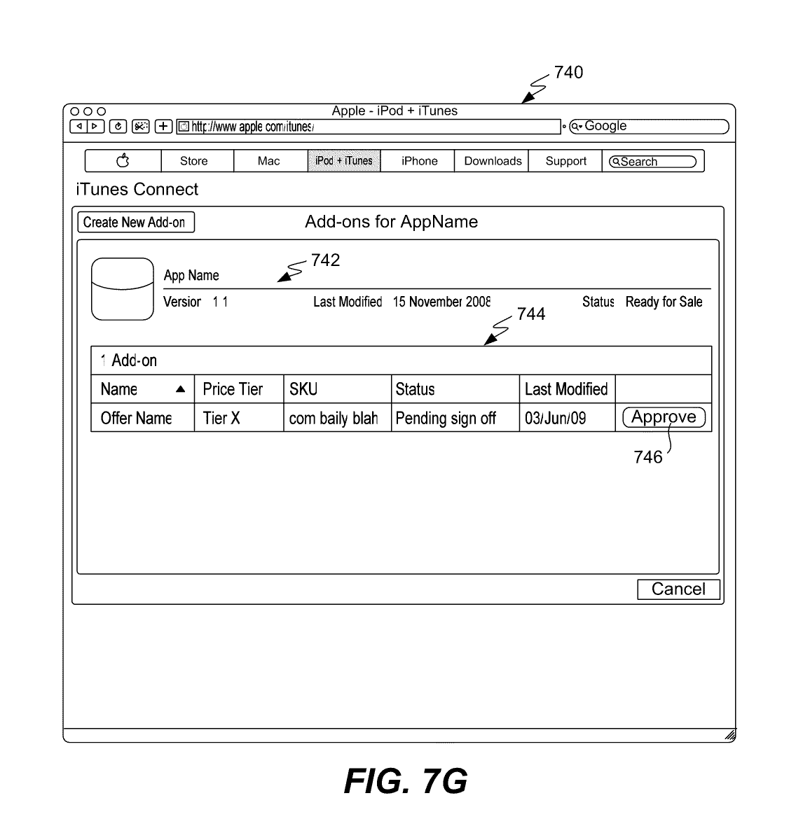

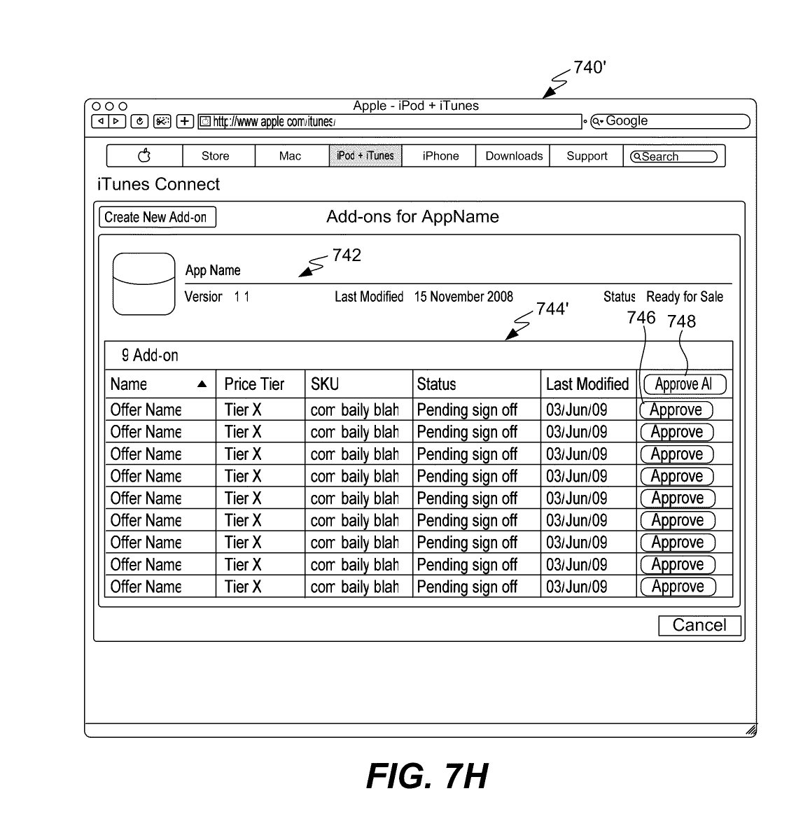

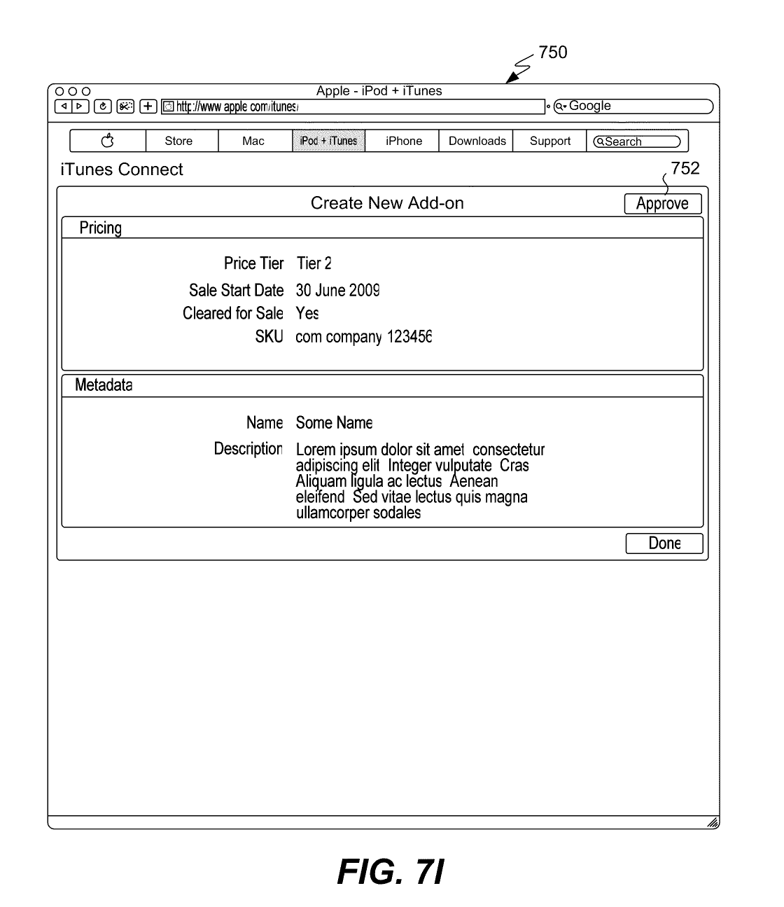

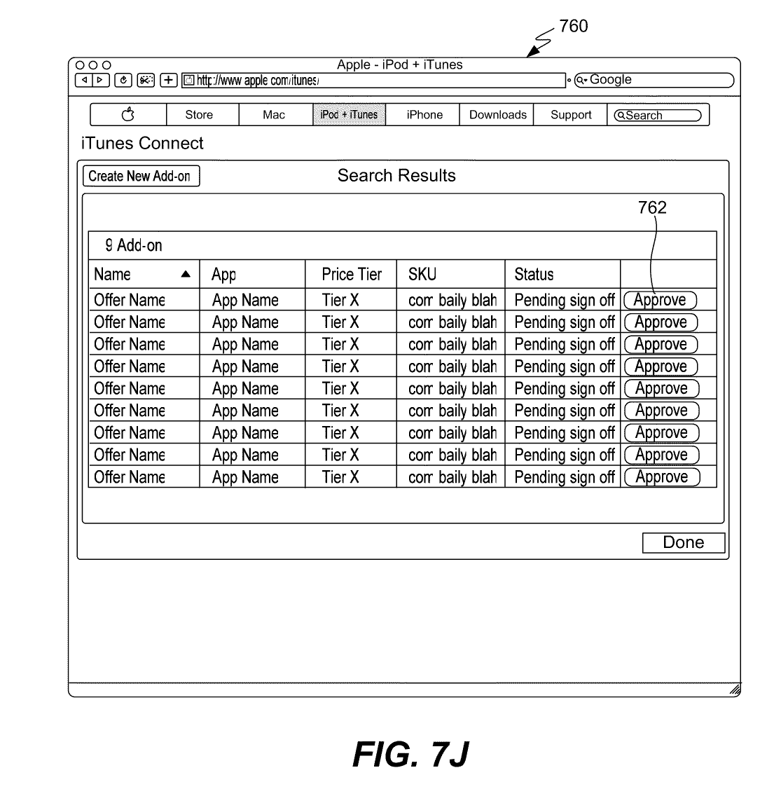

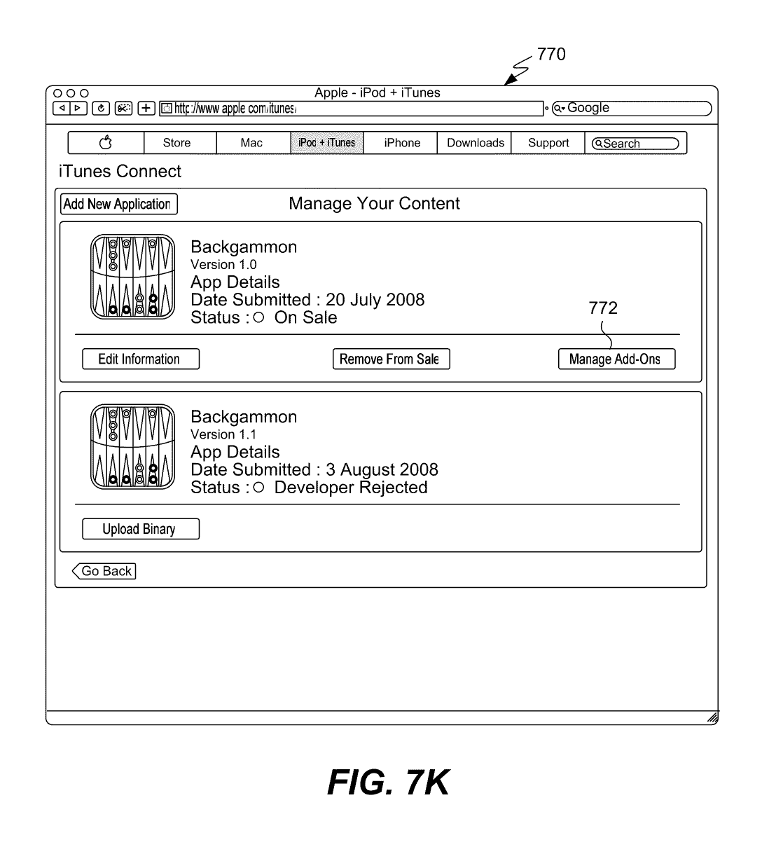

Another aspect pertains to graphical user interfaces. The graphical user interfaces can present various pages (or screens), including those discussed above, to assist a user in interacting with a product submission and management system (or an online product distribution site). FIGS. 7A-7K are screen shots pertaining to representative graphical user interfaces.

FIGS. 7A-7K are representative screen shots pertaining to basic user interaction with a product submission and management system according to one embodiment. The screen shots can pertain to screens, panes, windows or pages that can be presented for display on a display screen.

FIG. 7A is a representative screen shot of a system navigation page 700 according to one embodiment. The system navigation page 700 can provide user access to a plurality of functional modules, for example, a product management module 702 (“Manage Your Content”), a contract request module 704 (“Contract”), a financial module 706 (“Financial Reports”), an account management module 708 (“Manage Users”), or an add-on management module 709 (“Manage Your Offers”). These functional modules are similar to the modules 306-314 illustrated in FIG. 3. Offers are another term used for add-ons, since add-ons are enhancements that are offered by an application program, usually for a fee. The system navigation page 700 can, for example, represent the system navigation page 504 illustrated in FIG. 5.

FIG. 7B is a representative screen shot of an add-on management base page 710 according to one embodiment. The add-on management base page 710 can, for example, represent the add-on management base page 602 in FIG. 6A. The add-on management base page 710 can be utilized by a user to manage add-ons to a product submission and management system for eventual distribution by an online product distribution site. The add-on management base page 710 can also be utilized to initiate creation of an add-on submission to the product submission and management system. The add-on management base page 710 includes a new add-on window 712. The new add-on window 712 can list or otherwise identify any application that already have add-ons that have been submitted to the product submission and management system for eventual distribution by the online product distribution site. As illustrated in FIG. 7B, the new add-on window 712 is empty because the user has not yet added any applications for submission to the online product distribution site. The add-on management base page 710 can also include a create add-on button 714 (“Create New Add-on”) that on selection initiates processing to enable the user to create a new add-on.

FIG. 7C is a representative screen shot of an add-on management base page 710′ according to another embodiment. The add-on management base page 710′, like the add-on base management page 710, can be utilized by a user to manage add-ons to a product submission and management system for eventual distribution by an online product distribution site. The add-on management base page 710′ can also be utilized to initiate creation of an add-on submission to the product submission and management system. The add-on management base page 710′ includes a new add-on window 712′. The new add-on window 712′ can list or otherwise identify any application that already have add-ons that have been submitted to the product submission and management system for eventual distribution by the online product distribution site. As illustrated in FIG. 7C, the new add-on window 712′ illustrates a plurality of applications with add-ons that the user has already submitted to the product submission and management system. In this example, the applications with add-ons are display in a horizontal arrangement. The add-on management base page 710′ can also include the create add-on button 714 (“Create New Add-on”) that on selection initiates processing to enable the user to create a new add-on. Still further, the add-on management base page 710′ can include a search region 718 that enables a user to configure and initiate a search for add-ons that match specified search criteria selected from names, identifier (e.g., SKU number), price tier, or stores. IF a search is initiated, the search results can be presented as shown in FIG. 7J.

FIG. 7D is a representative screen shot of an application selection page 720 according to one embodiment. The application selection page 720 presents a list 722 of applications that are associated with the user (i.e., associated with user account of the user). For each application in the list 722, descriptive information for the application can be displayed. For example, the descriptive information can include an application name, graphic, version, status, and/or date last modified. The application selection page 720 can also include a select control 724 (e.g., select button) that enables the user to select one of the listed application for which the user desires to configure an add-on.

FIG. 7E is a representative screen shot of a metadata and distribution information page 730 according to one embodiment. The metadata and distribution information page 730 includes a pricing/distribution area 732, a metadata region 734, and a localization area 736. The pricing/distribution area 732 facilitates user entry of distribution parameters (or pricing parameters), such as a price or a price tier to be associated with the add-on, a sale start date and/or a cleared for sale flag. Other distribution parameters can pertain to a unique identifier (e.g., SKU number) to be used to identify the add-on. The metadata region 734 facilitates user entry of name and description for the add-on being configured. The localization area 736 facilitates support for user designation of add-on descriptions in multiple languages. For example, when the online product distribution site offers products for sale through use of different online stores associated with different countries or regions, it can be advantageous to provide localized add-on descriptions.

FIG. 7F is a representative screen shot of a metadata and distribution information page 730′ according to one embodiment. The metadata and distribution information page 730′ is generally similar to the metadata and distribution information page 730 illustrated in FIG. 7E except that a localization area 736′ is expanded to facilitate entry of localization information for the add-on being created. In FIG. 7E, upon selection of a language, the localization area 736 can expand to the localization area 736′ which facilitates user entry of a name and description for the add-on in the selected language.

FIG. 7G is a representative screen shot of an add-on listing page 740 according to one embodiment. The add-on listing page 740 includes descriptive information 742 for an application being displayed. For example, the descriptive information 742 can include an application name, graphic, version, status, and/or date last modified. Additionally, the add-on listing page 740 includes an add-on area 744 which lists one or more add-ons associated with the application described by the descriptive information 742. The one or more add-ons can be described by descriptive information such as add-on name, price tier, SKU number, status, and/or date last modified. For each add-on being listed, an approve control 746 (e.g., approve button) can be provided. Upon selection of the approve control 746, the add-on that has been configured can be approved (by the user) for distribution. In FIG. 7G, the add-on area 744 identifies only one add-on.

FIG. 7H is a representative screen shot of an add-on listing page 740′ according to one embodiment. The add-on listing page 740′ is generally similar to the add-on listing page 740 illustrated in FIG. 7F except that the add-on area 744′ lists a plurality of add-ons that are associated with the application described by the descriptive information 742. The descriptive information can include name, price tier, SKU, status and/or date last modified. Each of the add-ons is can be described by the descriptive information provided in the add-on area 744′. Each of the add-ons can also have a separate approve control 746 (e.g., approve button). Additionally, the add-on listing page 740′ can include an approval all control 748 (e.g., approve all button) so that all the add-ons listed in the add-on area 744′ can be approved with a single user selection.

FIG. 7I is a representative screen shot of an add-on view page 750 according to one embodiment. The selection of an add-on in the add-on area 744 or 744 of the add-on listing page 740 or 740′ can cause the add-on view page 750 to be presented. The add-on view page 750 can present pricing/distribution information as well as metadata information and any localization information for the particular add-on. The add-on view page 750 can also provide an approve control 752 (e.g., approve button) so that the user can elect to approve the add-on.

FIG. 7J is a representative screen shot of a search results page 760 according to one embodiment. The search results page 760 can present a list on those one or more add-ons that match certain search criteria. The one or more matching add-ons can be described by descriptive information such as add-on name, price tier, SKU number, status, and/or date last modified. Selection of one of the matching add-ons can cause the add-on view page 750 shown in FIG. 7I to be displayed. Also, for each add-on being listed, an approve control 762 (e.g., approve button) can be provided. Upon selection of the approve control 762, the add-on that has been configured can be approved (by the user) for distribution. The search criteria can be provided using the search region 718 illustrated in FIG. 7C.

FIG. 7K is a representative screen shot of an application management base page 770 according to one embodiment. The application management base page 770 can be utilized by a user to manage applications with respect to a product submission and management system for eventual distribution by an online product distribution site. Additional details on application management are provided in U.S. patent application Ser. No. 12/286,076, filed Sep. 26, 2008, entitled “ELECTRONIC SUBMISSION AND MANAGEMENT OF DIGITAL PRODUCTS FOR NETWORK-BASED DISTRIBUTION”, which is hereby incorporated herein by reference. The application management base page 770 can also be utilized to initiate creation of an add-on submission to the product submission and management system. Namely, selection of a manage add-on control 772 (e.g., manage add-ons button), can cause the add-on view page 750 shown in FIG. 7I to be displayed.

This application also references and/or incorporates: (1) U.S. patent application Ser. No. 10/687,534, filed Oct. 15, 2003, and entitled “METHOD AND SYSTEM FOR SUBMITTING MEDIA FOR NETWORK-BASED PURCHASE AND DISTRIBUTION”, which is hereby incorporated herein by reference; (2) U.S. patent application Ser. No. 11/609,815, filed Dec. 12, 2006, and entitled “TECHNIQUES AND SYSTEMS FOR ELECTRONIC SUBMISSION OF MEDIA FOR NETWORK-BASED DISTRIBUTION”, which is hereby incorporated herein by reference; (3) U.S. patent application Ser. No. 11/622,923, filed Jan. 12, 2007, and entitled “COMPUTERIZED MANAGEMENT OF MEDIA DISTRIBUTION AGREEMENTS”, which is hereby incorporated herein by reference; (4) U.S. patent application Ser. No. 12/286,076, filed Sep. 26, 2008, entitled “ELECTRONIC SUBMISSION AND MANAGEMENT OF DIGITAL PRODUCTS FOR NETWORK-BASED DISTRIBUTION”, which is hereby incorporated herein by reference; (5) U.S. Provisional Patent Application No. 61/050,478, filed May 5, 2008, entitled “ELECTRONIC SUBMISSION AND MANAGEMENT OF DIGITAL PRODUCTS FOR NETWORK-BASED DISTRIBUTION”, which is hereby incorporated herein by reference; (6) U.S. Provisional Patent Application No. 61/160,640, filed Mar. 16, 2009, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference; and (7) U.S. patent application Ser. No.______ [Att. Dkt. No.: 101-P679], filed Sep. 30, 2009, entitled “APPLICATION PRODUCTS WITH IN-APPLICATION SUBSEQUENT FEATURE ACCESS USING NETWORK-BASED DISTRIBUTION SYSTEM”, which is hereby incorporated herein by reference.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of the invention are numerous. Different embodiments or implementations may, but need not, yield one or more of the following advantages. One advantage of certain embodiments of the invention is that submission of digital products, such as computer programs (applications), to online distribution sites can be achieved by numerous persons (e.g., developers) with uniformity. The uniformity facilitates processing, approving and distributing the computer programs by representatives of the online distribution sites to process the digital product. Another advantage of certain embodiments of the invention is that digital product submissions can be user-controlled through information/authorizations provided with submission of digital products to online distribution sites. Still another advantage of certain embodiments of the invention is that users can gain online access to status information of digital product submission.

Additional information is provided in U.S. Provisional Patent Application No. 61/180,925, filed May 25, 2009, entitled “CONFIGURATION AND MANAGEMENT OF ADD-ONS TO DIGITAL APPLICATION PROGRAMS FOR NETWORK-BASED DISTRIBUTION”, which is hereby incorporated herein by reference. The Appendix A of the U.S. Provisional Patent Application No. 61/180,925 explains one exemplary framework for providing an add-on to an existing application and providing a transaction with an online store (e.g., Apple App Store) to process payment and then notify the corresponding application that the add-on should be made available to the user. The Appendix A of the U.S. Provisional Patent Application No. 61/180,925 refers to embedding a “store” in an application as one implementation for managing payment and access to the add-on.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A computer-implemented method for managing distribution of an add-on for a digital product by an online repository, the method comprising:
displaying a list of one or more application computer programs previously submitted to the online repository;
receiving a selection of one of the application computer programs previously submitted, the selected application computer program including an add-on contained therein whose access is locked;
receiving add-on management information to configure unlocking of the locked add-on; and
providing the add-on management information to the online repository for managing distribution of the add-on for the digital product for the selected application computer program to the online repository for distribution.

2. A method as recited in claim 1, wherein the digital product is a computer program product.

3. A method as recited in claim 1, wherein the add-on management information includes at least add-on information and at least one distribution parameter.

4. A method as recited in claim 3, wherein the add-on information and the at least one distribution parameter are provided by a submitter having a user account with the online repository, and
wherein the method further comprises:
authenticating the submitter with respect to the user account prior to permitting the providing of the add-on to the online repository.

5. A method as recited in claim 4, wherein the providing is prevented if the authenticating does not authenticate the submitter with respect to the user account.

6. A method as recited in claim 4, wherein the at least one distribution parameter is a pricing parameter.

7. A method as recited in claim 6, wherein the pricing parameter is a price tier.

8. A method as recited in claim 3, wherein the add-on information includes a unique identifier for the add-on.

9. A method as recited in claim 3, wherein the method further comprises:
receiving alternative language add-on information.

10. A method as recited in claim 3, wherein the add-on information includes at least an add-on name and an add-on description.

11. A method as recited in claim 1, wherein the add-on pertains to a feature within the digital product that is access-restricted.

12. A method as recited in claim 1, wherein the add-on is a component of the digital product for which access thereto is separately purchased.

13. A method as recited in claim 1, wherein the method further comprises:
receiving product information pertaining to a digital product to be submitted to the online repository;
uploading at least one electronic file pertaining to the digital product;
receiving at least one distribution parameter to be used for the digital product; and
submitting the digital product to the online repository for distribution.

14. A method as recited in claim 13, wherein the product information includes at least a product name, a supported device type indication, genre indication, version number, product identifier, support information, and license agreement information.

15. A computer readable storage medium including at least computer program code stored thereon for managing distribution of an add-on for a digital product by an online repository, the computer readable medium comprising:
computer program code for displaying a list of one or more application computer programs previously submitted to the online repository;
computer program code for receiving a selection of one of the application computer programs previously submitted, the selected application computer program including an add-on contained therein whose access is locked;
computer program code for receiving add-on management information to configure unlocking of the locked add-on; and
computer program code for providing the add-on management information to the online repository for managing distribution of the add-on for the digital product for the selected application computer program to the online repository for distribution.

16. A method as recited in claim 15, wherein the add-on information includes at least an add-on name and an add-on description, and
wherein the add-on management information includes at least add-on information and at least one distribution parameter.

17. A method as recited in claim 16, wherein the add-on pertains to a feature within the digital product that is access-restricted.

18. A system for facilitating submission and management of digital products to be distributed online, the system comprising:
a product management and distribution system configured to permit content providers to submit digital products and manage distribution of their digital products, the product management and distribution system including at least:
a product submission module configured to receive submission of digital products for distribution, each of the digital products being submitted including at least providing product information and product distribution information; and
an add-on submission module configured to receive submission of add-ons, the add-ons being distributed along with a corresponding one or more of the digital products, each of the add-ons being submitted including at least add-on information and add-on distribution information,
wherein the product information includes at least a product name and a supported device type indication, and wherein the product distribution information includes at least one pricing parameter for use in online distribution of the corresponding digital product, and
wherein the add-on information includes at least an add-on name and an add-on description, and wherein the add-on distribution information includes at least one pricing parameter for use in online distribution of the corresponding add-on.

19. A system as recited in claim 18, wherein the digital product is a computer program product.

20. A system as recited in claim 18, wherein the product information further includes at least a genre indication, version number, product identifier, support information, and license agreement information.

21. A system as recited in claim 18, wherein the add-on submission module is further configured to authenticate a submitter of the add-on prior to submission.

22. A system as recited in claim 18, wherein the pricing parameter is a price tier.

23. A system as recited in claim 18, wherein the add-on information further includes at least one of the add-on name or the add-on description in at least one alternative language.

24. A system as recited in claim 18, wherein the product distribution information further includes localization information to be associated with the digital product, and wherein the localization information is used to cause presentation of the corresponding digital product at the different online storefronts to differ.

25. A system for facilitating submission and management of digital products to be distributed online, the system comprising:
a product management and distribution system configured to permit content providers to submit information for use in distribution of add-ons for digital products and manage access to the add-ons, the product management and distribution system including at least:
an add-on submission module configured to receive submission of add-ons, the add-ons being distributed along with a corresponding one or more of the digital products, each of the add-ons being submitted including at least add-on information and add-on distribution information,
wherein the add-on information includes at least an add-on name and an add-on description, and wherein the add-on distribution information includes at least one pricing parameter for use in online distribution of the corresponding add-on.

26. A graphical user interface for use in submitting a digital product to an online distribution site, the graphical user interface comprising:
an add-on creation window for assisting a user in designating an application program to support an add-on, the designated application program being previously submitted to the online distribution site, and the designated application program including computer program code for not only the designated application program but also at least one add-on; and
an add-on creation window for assisting the user in providing at least a pricing parameter for the add-on and add-on metadata for the add-on for the designated application program.

27. A method for submitting an add-on for a digital product to an online repository for distribution, the method comprising:
receiving add-on information pertaining to the add-on for the digital product to be distributed by the online repository;
receiving at least one distribution parameter to be used for the add-on; and
submitting the add-on to the online repository for distribution.
